(19) United States
(12) Patent Application Publication
(10) Pub. No.: US 2015/0020137 A1
(43) Pub. Date: Jan. 15, 2015

(54) PRESENTATION CONTROL APPARATUS, PRESENTATION CONTROL METHOD, PRESENTATION SYSTEM, PRESENTATION CONTROL PROGRAM, RECORDING MEDIUM, AND METADATA

(71) Applicant: SHARP KABUSHIKI KAISHA, Osaka-shi, Osaka (JP)

(72) Inventors: Takuya Iwanami, Osaka-shi (JP); Shuichi Watanabe, Osaka-shi (JP); Yasuaki Tokumo, Osaka-shi (JP)

(21) Appl. No.: 14/375,618

(22) PCT Filed: Dec. 18, 2012
(86) PCT No.: PCT/JP2012/082727

§ 371 Date: Jul. 30, 2014

(30) Foreign Application Priority Data
Jan. 31, 2012 (JP) 2012-019148

(51) Int. Cl. H04N 21/235

(52) U.S. Cl. CPC H04N 21/2353
USPC 725/116

(57) ABSTRACT

Provided is a presentation control apparatus that is enabled to control a presentation form of video content on each device so that the video content is presented in a fashion reflecting a content provider's intention. Based on metadata transmitted from a transmitter apparatus, a component separator of a television receiver selects from two devices including the television receiver and a tablet terminal a device on which a video component is to be presented and causes the selected one or two devices to present the video component.

### TECHNICAL FIELD

The present invention relates to a presentation control apparatus, a presentation control method, and a presentation control program for presenting video content on each of a plurality of devices. The present invention also relates to a presentation system including such a presentation control apparatus, and a recording medium having stored such a presentation control program. The present invention also relates to metadata related to the video content.

### BACKGROUND ART

The video content has been conventionally delivered only via a broadcasting network. With the widespread use of a broadband Internet connection, the video content is today delivered using the Internet.

In the hybrid transmission technique disclosed in Patent Literature 1, Patent Literature 2, and other literature, some components forming video content is transmitted via a broadcasting network while the remaining components are transmitted via a communication network.

### CITATION LIST

### Patent Literature

PTL 1: Japanese Unexamined Patent Application Publication No. 2005-286748 (disclosed Oct. 13, 2005)
PTL 2: Japanese Unexamined Patent Application Publication No. 10-173612 (disclosed Jun. 26, 1998)

### SUMMARY OF INVENTION

### Technical Problem

There are cases where a user displays video content transmitted from a delivery source on a plurality of devices. For example, a presenter may now present something using video content. The presenter may cause a notebook PC at hand to receive video content delivered by a moving image provider site, and may display part or whole of a video simultaneously on the notebook PC and on a large-screen display that is installed to allow a large audience to view the video. In another example, a viewer may view video content. The viewer may cause a television receiver (hereinafter simply referred to as TV) at hand to receive video content delivered from a moving image provider site, and may display part or whole of a video simultaneously on the TV and on a mobile terminal arranged so that the viewer may view the video.

In the former case, the notebook PC is typically configured so that the video is displayed on both the notebook PC and the large-screen display as described above, only on the notebook PC, or only on the large-screen display.

There may be cases where a content provider desires to reflect the provider's intention to control switching as to whether or not the video control is to be simultaneously displayed on a plurality of devices.

In the configuration described above, however, the decision as to whether the video content is to be simultaneously displayed on a plurality of devices is fully left to a content user (the user of the notebook PC). In other words, the content provider has no choice of reflecting his intention in the decision as to whether the video content is to be simultaneously displayed on a plurality of devices.

In view of the above problem, the present invention has been developed. It is an object of the present invention to provide a presentation control apparatus that is enabled to control a presentation form of video content on each device so that the video content is presented in a manner reflecting a content provider's intention.

### Solution to Problem

A presentation control apparatus of the present invention is enabled to present video content on N devices (N≧2) based on metadata of the video content. The presentation control apparatus includes a decision unit configured to decide from among the N devices a device that is to present a video component included in the video content, and a presentation control unit configured to cause one or more devices to present the video component in accordance with a decision of the decision unit. The metadata includes presentation condition information as to whether to permit the video component to be simultaneously presented on two or more devices. The decision unit is configured to decide from among the N devices a device that is to present the video component if a reference to the presentation condition information determines the simultaneous presentation of the component to be not permissible.

As long as the metadata related to the video content is produced reflecting the intention of a content provider, the presentation control apparatus of the present invention configured described above presents the video content on one or more devices in a presentation form reflecting the intention of the content provider.

A presentation system including the presentation control apparatus and the N devices falls within the scope of the present invention. As described above, the presentation control apparatus may be one of the N devices or may be a device different in type from the N devices.

A program causing a computer to function as the presentation control apparatus of the present invention and as each element in the presentation control apparatus falls within the scope of the present invention. A computer readable recording medium having stored the program falls within the scope of the present invention.

Metadata related to the video content falls within the scope of the present invention. More specifically, the metadata is configured to be referenced by the presentation control apparatus enabled to present video content including a video component on N devices (N≧2), and includes presentation condition information indicating whether to permit the video component to be presented simultaneously on two or more devices. Such metadata falls within the scope of the present invention.

### Advantageous Effects of Invention

As described above, the presentation control apparatus of the present invention controls the presentation form of the video content on each device so that the video content is presented in a fashion reflecting a content provider's intention.

### BRIEF DESCRIPTION OF DRAWINGS

FIG. 1 illustrates the configuration of a delivery system of one embodiment of the present invention, and the configuration of main elements of each apparatus included in the delivery system.

FIG. 2(a) is a flowchart illustrating a particular operation of the TV of FIG. 1, and FIG. 2(b) is a flowchart illustrating a particular operation of a tablet terminal of FIG. 1.

FIG. 3 diagrammatically illustrates metadata transmitted by a transmitter apparatus of FIG. 1 and received by the TV of FIG. 1.

FIG. 4 illustrates an example of a presentation form of video content on the TV of FIG. 1 and the tablet terminal of FIG. 1, wherein FIG. 4(a) diagrammatically illustrates an example of a region of a display of the TV of FIG. 1 where each component is displayed, and FIG. 4(b) diagrammatically illustrates an example of a region of a display of the tablet terminal of FIG. 1 where each component is displayed.

FIG. 5 is a flowchart illustrating a particular operation of the TV of FIG. 1.

FIG. 6 diagrammatically illustrates metadata transmitted by the transmitter apparatus of FIG. 1 and received by the TV of FIG. 1.

FIG. 7 is a flowchart illustrating a particular operation of the TV of FIG. 1.

FIG. 8 diagrammatically illustrates an example of the metadata transmitted by the transmitter apparatus of FIG. 1 and received by the TV of FIG. 1.

FIG. 9 diagrammatically illustrates an example of data structure of device management information stored on a memory of the TV of FIG. 1.

FIG. 10 diagrammatically illustrates the metadata transmitted by the transmitter apparatus of FIG. 1 and received by the TV of FIG. 1.

FIG. 11 is a flowchart illustrating a particular operation of the TV of FIG. 1.

FIG. 12 diagrammatically illustrates an example of the metadata transmitted by the transmitter apparatus of FIG. 1 and received by the TV of FIG. 1.

FIG. 13 diagrammatically illustrates an example of the metadata transmitted by the transmitter apparatus of FIG. 1 and received by the TV of FIG. 1.

FIG. 14 illustrates the configuration of a delivery system of another embodiment of the present invention, and the configuration of main elements of each apparatus included in the delivery system.

FIG. 15 diagrammatically illustrates an example of the metadata transmitted by the transmitter apparatus of FIG. 1 and received by the TV of FIG. 1.

FIG. 16 diagrammatically illustrates an example of the metadata transmitted by the transmitter apparatus of FIG. 1 and received by the TV of FIG. 1.

FIG. 17 is a flowchart illustrating a particular operation of the TV of FIG. 1.

### DESCRIPTION OF EMBODIMENTS

### First Embodiment

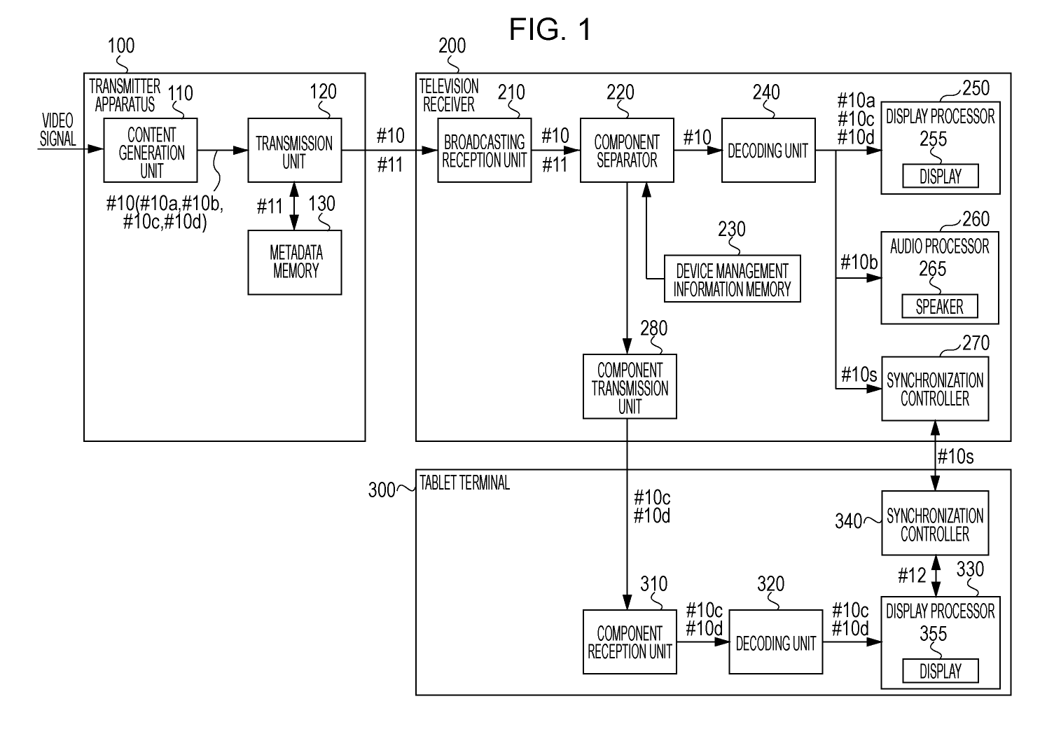

A delivery system of a first embodiment is described with reference to FIG. 1 through FIG. 13.

The delivery system of the embodiment of the present invention is a display system including a transmitter apparatus configured to deliver video content and a display apparatus (a TV and a tablet terminal) configured to present the video content. The video content includes a plurality components.

The TV references metadata information delivered together with the video content by the transmitter apparatus and decide between presenting each component on the TV itself or also causing the tablet terminal to present each component.

The tablet terminal is a device registered on the TV, and is configured to present a component transferred from the TV with the tablet terminal connected to the TV.

In the discussion that follows, the delivery system is described based on the premise that video content includes four components, namely, a video component, an audio component, a data component, and a text (subtitle) component.

The configuration of main elements of devices including, the transmitter apparatus, the TV, the tablet terminal in the delivery system of the present embodiment are described with reference to FIG. 1.

FIG. 1 is a block diagram illustrating the configuration of the main elements of each device.

As illustrated in FIG. 1, the delivery system 1 includes a transmitter apparatus 100, a TV 200, and a tablet terminal 300.

Transmitter Apparatus 100

The transmitter apparatus 100 includes a content generation unit 110, a transmission unit 120, and a metadata memory 130.

The content generation unit 110 generates video content by performing a coding process on a video signal input to the transmitter apparatus 100 from the outside.

The transmission unit 120 transmits video content and metadata of the video content over a carrier wave.

The metadata memory 130 stores the metadata of the video content transmitted by the transmission unit 120. The metadata is pre-edited so that the intention of a deliverer of the video content is reflected in the video content.

TV 200

The TV 200 includes a broadcasting reception unit 210, a component separator 220, a device management information memory 230, a decoding unit 240, a display processor 250, an audio output unit 260, a synchronization controller 270, and a component transmission unit 280.

The broadcasting reception unit 210 is a tuner to receive a broadcasting wave.

The component separator 220 separates a video component, an audio component, a data component, and a text component from the video content acquired through the reception of the broadcasting wave.

The component separator 220 references the metadata of the video content and determines whether to present each component on the TV 200 or the tablet terminal 300. The component separator 220 supplies to the component transmission unit 280 the component that is decided to be presented on the tablet terminal 300. The component separator 220 supplies to the decoding unit 240 the component that is decided to be presented on the TV 200.

The device management information memory 230 stores, as device management information, specifications information of the TV 200 and specifications information of the tablet terminal 300. The specifications information of the tablet terminal 300 is received from the tablet terminal 300 in a case that the tablet terminal 300 is registered on the TV 200.

The device management information memory 230 also stores attribute information as the device management information. The attribute information indicates whether each of the TV 200 and the tablet terminal 300 is a main device or a sub device. The attribute information is stored (or modified) in response to an instruction from a user input to an operation unit (not illustrated) of the TV 1. If the user specifies the TV 200 to be a main device in a state with “second device” stored as the attribute information of the TV 200, the attribute information of the TV 200 is modified from “second device” to “first device”. The attribute information of the TV 200 may be stored on the device management information memory 230 at the shipment of the TV 200. The attribute information of the tablet terminal 300 may be pre-stored on a memory (not illustrated) of the tablet terminal 300 at the shipment of the tablet terminal 300. In a case that the tablet terminal 300 is registered on the TV 200, the attribute information of the tablet terminal 300 may be stored on the device management information memory 230 as the device management information.

Device addresses of the TV 200 and the tablet terminal 300 are stored on the device management information memory 230.

The decoding unit 240 decodes the component supplied from the component separator 220.

The display processor 250 performs a variety of operations to display a video on the display 255. The display 255 is included in the display processor 250.

The audio output unit 260 performs a variety of operations to output audio to the speaker 265. The speaker 265 is included in the audio processor 260.

The synchronization controller 270 transmits to the tablet terminal 300 a synchronization signal that is used to synchronize the presentation of the component on the TV 200 with the presentation of the component on the tablet terminal 300.

The component transmission unit 280 transmits to the tablet terminal 300 the component supplied from the component separator 220.

The synchronization controller 270 and the component transmission unit 280 may be configured to perform radio communications, such as WiFi communications, Bluetooth (registered trademark) or infrared communications, or may be configured to perform wired communications via HDMI cable.

Tablet Terminal 300

The tablet terminal 300 includes a component reception unit 310, a decoding unit 320, a display processor 330, and a synchronization controller 340.

The component reception unit 310 receives the component transmitted from the TV 200 and then supplies the received component to the decoding unit 320.

The decoding unit 320 decodes the component supplied from the component reception unit 310.

The display processor 330 performs a variety of operations to display a video on a display 335. The display 335 is included in the display processor 330.

In response to a synchronization signal #10s transmitted from the TV 200, the synchronization controller 340 controls the timing at which the tablet terminal 300 presents the component.

As those in the TV 200, the component reception unit 310 and the synchronization controller 340 may be configured to perform radio communications, such as WiFi communications, Bluetooth (registered trademark) or infrared communications, or may be configured to perform wired communications via HDMI cable.

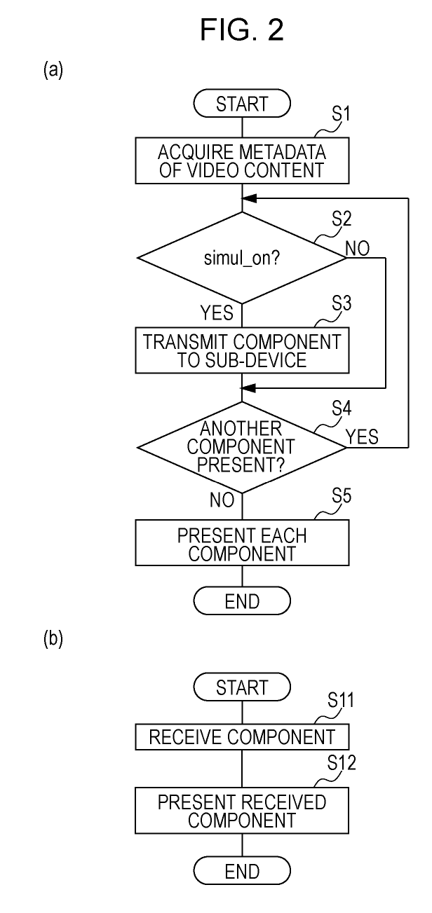

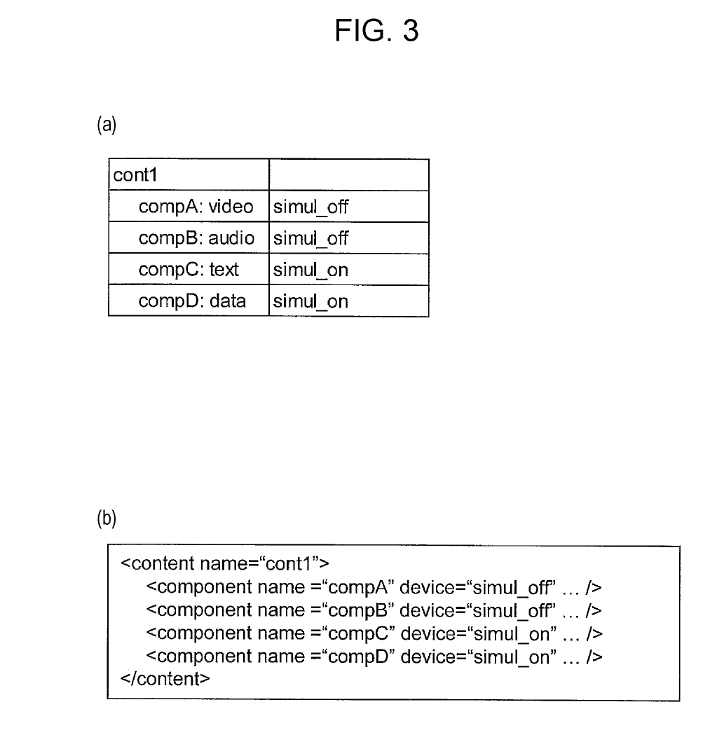

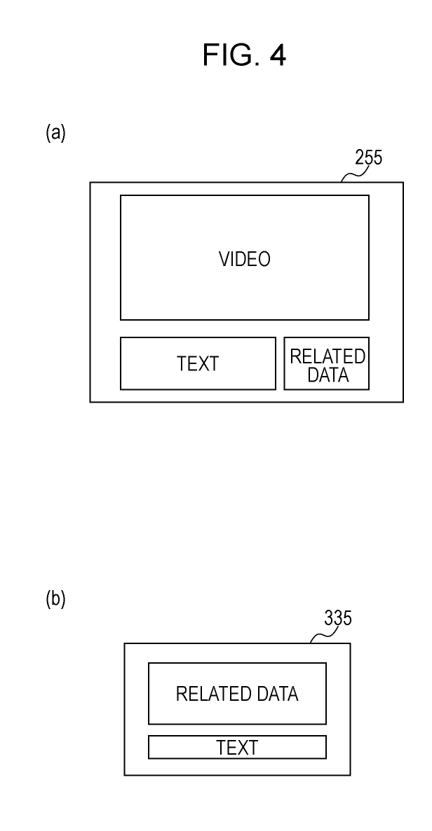

The operation of the TV 200 and the tablet terminal 300 to start the presentation of the video content is described with reference to FIG. 2 through FIG. 4. FIG. 2(a) is a flowchart illustrating the operation of the TV 200, and FIG. 2(b) is a flowchart illustrating the operation of the tablet terminal 300. FIG. 3 diagrammatically illustrates the metadata. FIG. 3(a) diagrammatically illustrates csv data in a table format as an example of the metadata, and FIG. 3(b) illustrates XML data representing the same content as the csv data of FIG. 3(a). In FIG. 3, “compA” through “compD” respectively represent component names of video, audio, text, and data. FIG. 4(a) illustrates an example of a video displayed on the TV 200, and FIG. 4(b) illustrates an example of a video displayed the tablet terminal 300.

As illustrated in FIG. 2(a), first, the broadcasting reception unit 210 in the TV 200 receives metadata #11 of the video content first while starting to receive the video content #10 (S1).

The metadata #11 of the video content includes information indicating that components #10a through #10d included in the video content #10 are to be simultaneously presented on the two devices and information indicating that components #10a through #10d included in the video content #10 are to be presented only on the TV 200. In the example of FIG. 3(a) and FIG. 3(b), “simul_on” is the former information and “simul_off” is the latter information. The metadata of FIG. 3(a) and FIG. 3(b) indicates that the components #10a and #10b of the video and audio associated with “simul_off” are to be presented only on the TV 200. Similarly, the metadata of FIG. 3(a) and FIG. 3(b) indicates that the components #10c and #10d of the text and data associated with “simul_on” are to be presented on both the TV 200 and the tablet terminal 300.

The component separator 220 in the TV 200 determines which of “simul_on” and “simul_off” is associated with the name of an i-th component from the front of the metadata #11 (if the immediately preceding step is S1, i=1) (S2). More specifically, if the metadata is in an XML format, the component separator 220 determines whether an attribute value of attribute “device” of an i-th “component” tag from the front of the metadata #11 is “simul_on” or “simul_off”.

If the component separator 220 determines that “the attribute value is associated with ‘simul_on’” (“Yes” branch from S2), the TV 200 starts transmitting the i-th component to the tablet terminal 300 (S3), and proceeds to S4. More specifically, the component separator 220 supplies the i-th component to the component transmission unit 280, and the component transmission unit 280 transmits the i-th component to the tablet terminal 300.

If the component separator 220 determines that “the attribute value is associated with ‘simul_off’” (“No” branch from S2), processing proceeds to S4.

In S4, the component separator 220 in the TV 200 determines whether the operation in S2 has been performed on all components.

If the TV 200 determines that “there is still present a component that has not undergone the operation in S2” (“Yes” branch from S4), the TV 200 returns to S2 with an (i+1)-th component as operation target. On the other hand, if the TV 200 determines that “the operation in S2 has been performed on all the components” (“No” branch from S4), processing proceeds to S5.

In S5, the TV 200 starts presenting each component. More specifically, the component separator 220 supplies each component to the decoding unit 240. The decoding unit 240 decodes each component, and then supplies to the display processor 250 the components #10a, #10c, and #10d of video, text, and data. The decoding unit 240 supplies the audio component #10b to the audio processor 260. The display processor 250 processes the components #10a, #10c, and #10d of video, text, and data, thereby displaying a video on the display 255. The audio processor 260 processes the audio component #10b, thereby outputting audio from the speaker 265.

The operation in 85 completes the operation to start the presentation of the video content.

While supplying the component to the display processor 250 and the audio processor 260, the decoding unit 240 periodically supplies PCR (program clock reference) #10s as a synchronization signal to the synchronization controller 270. The synchronization controller 270 adjusts system time of the TV 200 to match PCR#10s, while transmitting PCR#10s to the tablet terminal 300.

As clear from the above discussion, upon receiving the metadata of FIG. 3 in S1, the TV 200 presents the components #10a, #10c, and #10d of video, text, and data and transmits the components #10c and #10d of text and data to the tablet terminal 300.

An operation of the tablet terminal 300 to start the presentation of the video content is described below.

As illustrated in FIG. 2(b), the component reception unit 310 in the tablet terminal 300 starts receiving the component transmitted from the TV 200 (S11).

The tablet terminal 300 starts presenting each component (S12). More specifically, the component reception unit 310 supplies each component transmitted from the TV 200 to the decoding unit 320. The decoding unit 320 starts decoding the component supplied from the component reception unit 310, and supplies each decoded component to the display processor 330. The display processor 330 starts displaying the video on the display 335 by processing the component.

The tablet terminal 300 presents the components #10c and #10D of text and data in a case that the TV 200 receives the metadata of FIG. 3 in S1. As a result, videos of screens of FIG. 4(a) and FIG. 4(b) are respectively displayed on the display 255 of the TV 200 and the display 335 of the tablet terminal 300.

With the tablet terminal 300 remaining connected to the TV 200, the synchronization controller 340 waits for the transmission of PCR from the TV 200. Upon receiving PCR#10s, the synchronization controller 270 adjusts system time #12 of the tablet terminal 300 to match PCR#10s. The display processor 330 controls the presentation timing of each ES (elementary stream) forming the component in accordance with information of the system time #12 supplied from the synchronization controller 340.

The operation of the TV 200 and the tablet terminal 300 has been described. However, the TV 200 may be modified to operate as described below.

Modification 1

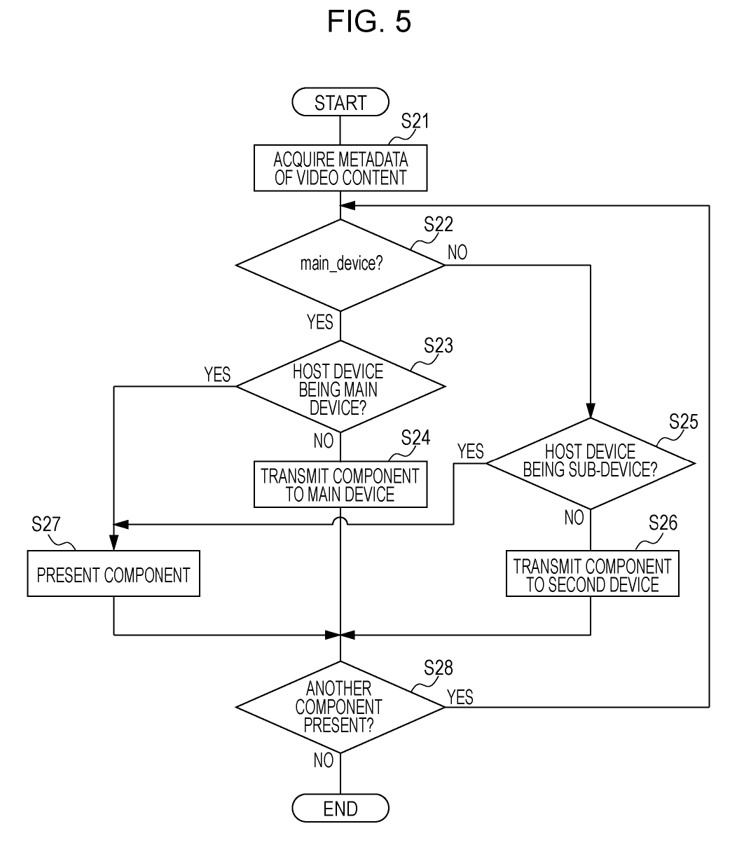

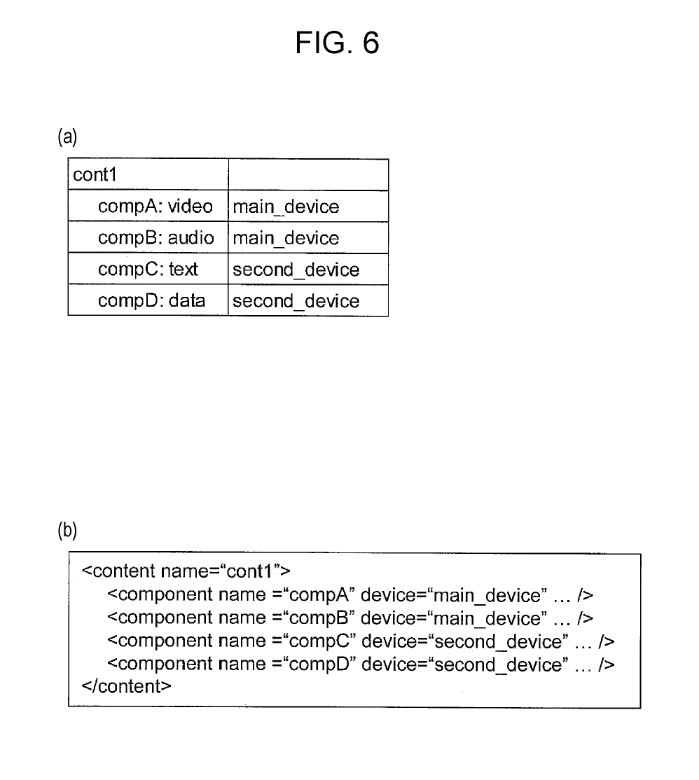

The operation of the modification 1 of the TV 200 is described with reference to FIG. 5 and FIG. 6. FIG. 5 is a flowchart illustrating the operation of the TV 200. FIG. 6 diagrammatically illustrates a specific example of the metadata. FIG. 6(a) diagrammatically illustrates csv data in a table format as an example of the metadata, and FIG. 6(b) illustrates XML data representing the same content as the csv data of FIG. 6(a). In FIG. 6, “compA” through “compD” respectively represent component names of video, audio, text, and data.

As illustrated in FIG. 5, first, the broadcasting reception unit 210 in the TV 200 receives the metadata of the video content while starting to receive the video content (S21).

The metadata of the video content includes a character string specifying that each component included in the video content is to be presented on the main device or a character string specifying that each component included in the video content is to be presented on the sub device. In the examples of FIG. 6(a) and FIG. 6(b), “main_device” corresponds to the former character string, and ‘second_device’ corresponds to the latter character string.

The component separator 220 in the TV 200 determine whether the name of the i-th component (i=1 if the immediately preceding step is S21) from the front of the metadata is associated with “main_device” or “second_device” (S22).

Upon determining that the name of the i-th component is associated with “main_device” (“Yes” branch from S22), the TV 200 determines whether each of the host device and the tablet terminal 300 is registered as one of the main device or the sub device (S23). More specifically, the component separator 220 accesses the device management information memory 230, and determines which character string, “main_device” or “second_device” is stored as the attribute information of the TV 200. Similarly, the component separator 220 determines which character string, “main_device” or “second_device” is stored as the attribute information of the tablet terminal 300.

Upon determining that “the host device has been registered as the main device” (“Yes” branch from S23), the TV 200 starts presenting the i-th component (S27), and proceeds to S28. On the other hand, upon determining that “the host device has been registered as the sub device” (“No” branch from S23), the TV 200 starts transmitting the i-th component to the tablet terminal 300 as the main device (S24), and proceeds to S28.

Upon determining that the name of the i-th component is associated with “second_device” (“No” branch from S22) as well, the TV 200 determines whether each of the host device and the tablet terminal 300 is registered as one of the main device or the sub device (S25).

Upon determining that “the host device is registered as the sub device” (“Yes” branch from S25), the TV 200 starts presenting the i-th component (S27), and proceeds to S28. Upon determining that “the hoist device is registered as the main device” (“No” branch from S25), the TV 200 starts transmitting the i-th component to the tablet terminal 300 as the sub device (S26), and proceeds to S28.

In S28, the component separator 220 in the TV 200 determines whether the operation in S22 has been performed on all the components.

Upon determining that “there is still a component that has not undergone the operation in S22” (“Yes” branch from S28), the TV 200 returns to the operation in S22 with a (i+1)-th component as being a process target. On the other hand, upon determining that “the operation in S22 has been completed on all the components” (“No” branch from S28), the TV 200 completes the operation to start the presentation of the video content.

Modification 2

Three or more display devices to present the video content may be used.

In a case that the three display devices to present the video content include a single TV 200 and two tablet terminals 300-1 and 300-2, the TV 200 may be modified as a modification 2 as described below.

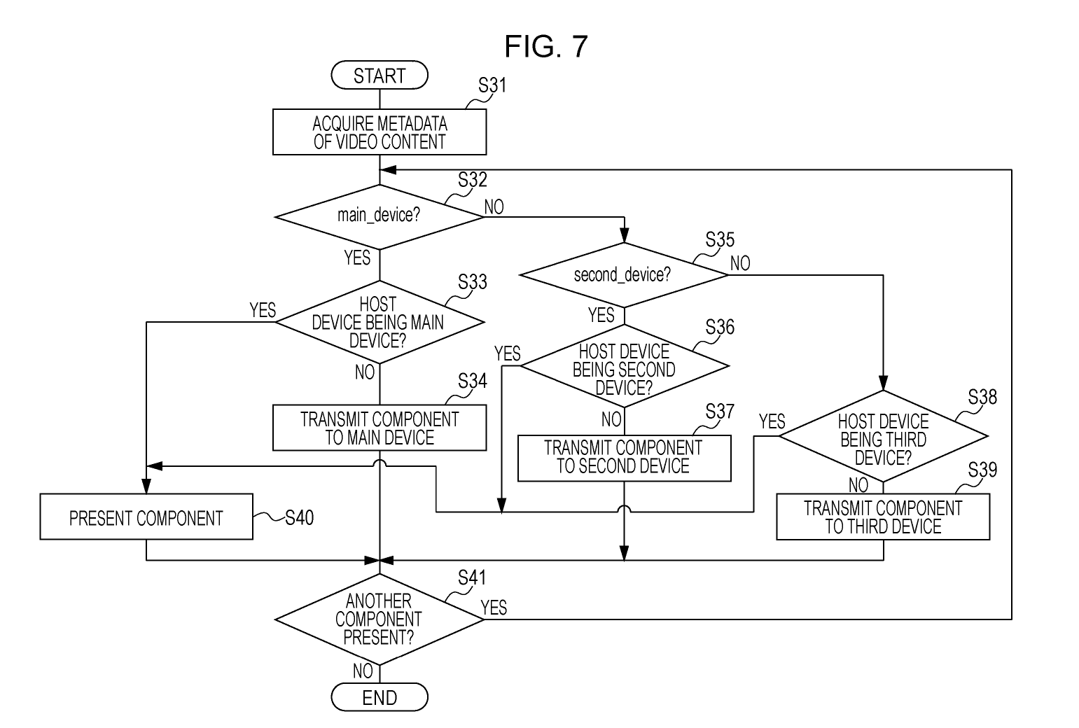

The operation of the modification 2 of the TV 200 is described with reference to FIG. 7 through FIG. 9.

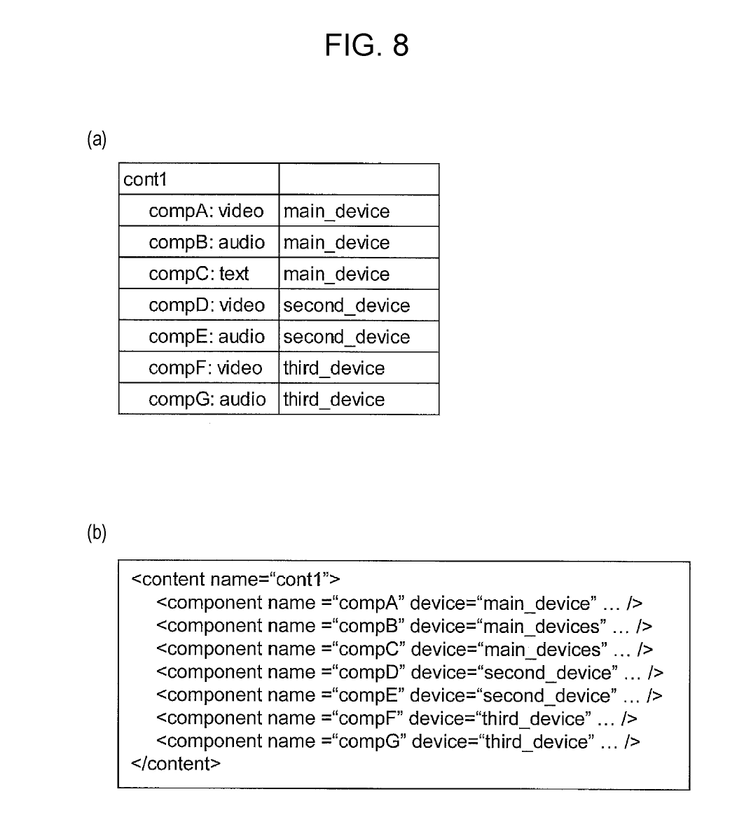

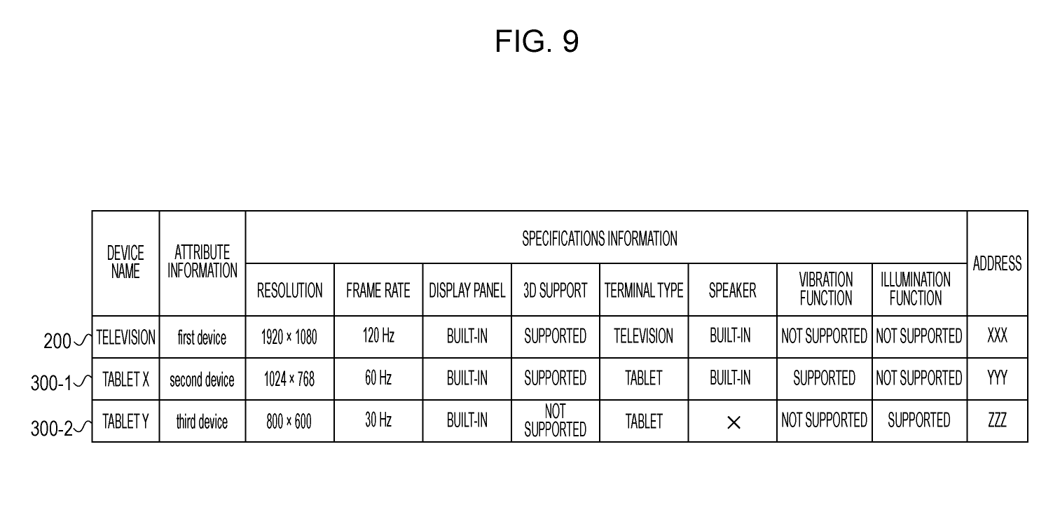

FIG. 7 is a flowchart illustrating the operation of the TV 200. FIG. 8 diagrammatically illustrates a specific example of the metadata. FIG. 8(a) diagrammatically illustrates csv data in a table format as a specific example of the metadata, and FIG. 8(b) illustrates XML data representing the same content as the csv data of FIG. 8(a). In FIG. 8, “compA” through “compD” respectively represent component names of video (high quality), audio (high sound quality), and text. In FIG. 8, “compD” and “compE” respectively represent component names of video (intermediate quality), and audio (intermediate sound quality), and “compF” and “compG” respectively represent component names of video (low quality), and audio (low sound quality). FIG. 9 diagrammatically illustrates a data structure of the device management information.

Referring to FIG. 7, first, the broadcasting reception unit 210 in the TV 200 receives the metadata of the video content while starting to receive the video content (S31).

The metadata herein includes a character string specifying that each component in the video content is to be presented on the main device, a character string specifying that each component in the video content is to be presented on the second device, or a character string specifying that each component in the video content is to be presented on a third device. In the examples of FIG. 8(a) and FIG. 8(b), the three character strings correspond to “main_device”, “second_device”, and “third_device”.

The component separator 220 in the TV 200 determines whether the name of the i-th component from the front of the metadata (i=1 if the immediately preceding step is S31) is associated with the character string “main_device” (S32).

Upon determining that the name of the i-th component is associated with the character string “main_device” (“Yes” branch from S32), the TV 200 determines whether each of the host device and the two tablet terminals 300-1 and 300-2 is registered as one of the main device, the second device, and the third device (S33). More specifically, the component separator 220 accesses the device management information memory 230 and determines whether one of the character strings “main_device”, “second_device”, and “third_device” is registered as the attribute information of the TV 200. Similarly, the component separator 220 determines whether one of the character strings “main_device”, “second_device”, and “third_device” is registered as the attribute information of each of the tablet terminals 300-1 and 300-2.

Upon determining that “the host device is registered as the main device” (“Yes” branch from S33), the TV 200 starts presenting the i-th component (S40) and then proceeds to S41. On the other hand, upon determining that “the host device is registered as the second device or the third device” (“No” branch from S33), the TV 200 starts transmitting the i-th component to the main device (S34) and then proceeds to S41.

Upon determining that “the name of the i-th component not is associated with the character string ‘main_device’ (“No” branch from S32), the TV 200 determines whether the name of the i-th component is associated with the character string “second_device” or “third_device” (S35).

Upon determining that “the name of the i-th component is associated with the character string ‘second_device’” (“Yes” branch from S35), the TV 200 determines whether each of the host device, and the two tablet terminals 300-1 and 300-2 is registered as the main device, the second device, or the third device (S36). Upon determining that “the host device is registered as the second device” (“Yes” from S36), the TV 200 starts presenting the i-th component (S40), and proceeds to S41. On the other hand, upon determining that “the host device is registered as the main device or the third device” (“No” branch from S36), the TV 200 starts transmitting the i-th component to the second device (S37), and proceeds to S41.

Upon determining that “the name of the i-th component is associated with “third_device” (“No” branch from S35), the TV 200 also determines whether each of the host device, and the two tablet terminals 300-1 and 300-2 is registered as the main device, the second device, or the third device (S38). Upon determining that “the host device is registered as the third device” (“Yes” from S38), the TV 200 starts presenting the i-th component (S40), and proceeds to S41. On the other hand, upon determining that “the host device is registered as the main device or the second device” (“No” branch from S38), the TV 200 starts transmitting the i-th component to the third device (S39), and proceeds to S41.

In S41, the component separator 220 in the TV 200 determines whether the operation in S32 has been performed on all the component.

Upon determining that “there is still a component that has not undergone the operation in S32” (“Yes” branch from S41), the TV 200 returns to the operation in S32 with a (i+1)-th component as being a process target. On the other hand, upon determining that “the operation in S32 has been completed on all the components” (“No” branch from S41), the TV 200 completes the operation to start the presentation of the video content.

In a case that the TV 200 receives the metadata of FIG. 8 in S31 with the device management information of FIG. 9 stored on the device management information memory 230, the TV 200 presents the components of video (high quality), audio (high sound quality), and text. Similarly, the tablet terminal 300-1 presents the components of video (intermediate quality) and audio (intermediate sound quality), and the tablet terminal 300-2 presents the components of video (low quality) and audio (low sound quality).

Modification 3

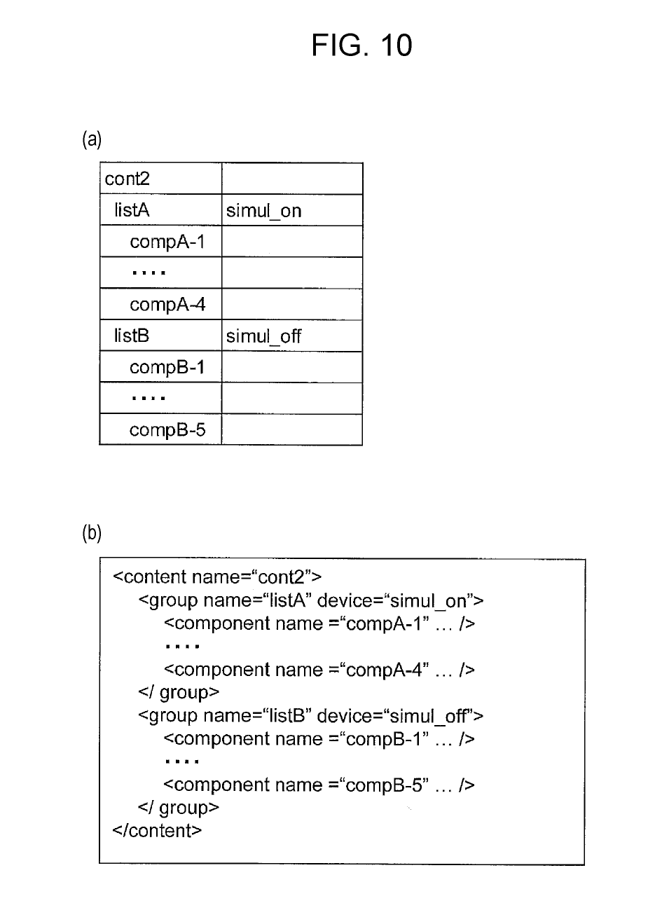

The metadata of the video content may not necessarily have to include the presentation condition information, such as “simul_on” and “simul_off” on each component of the video content. More specifically, as illustrated in FIG. 10, the metadata may include information of a group of components having the same presentation condition, and may thus include the presentation condition information, such as “simul_on” or “simul_off” on a per group basis.

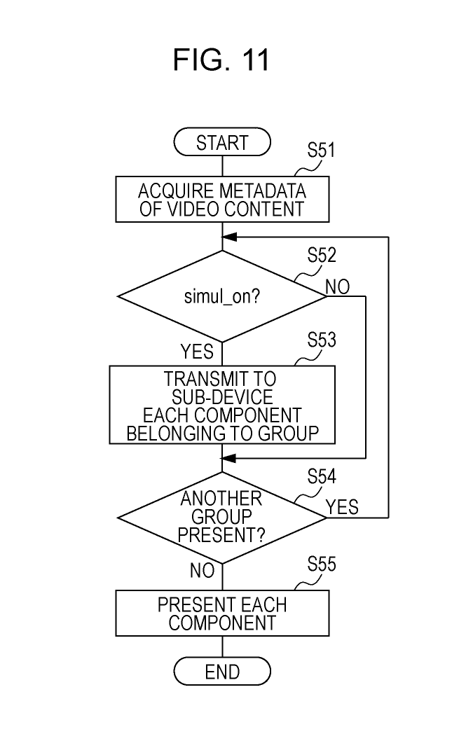

The TV 200 may be configured to operate as described with a modification 3 in response to the reception of such metadata. The operation of the modification 3 of the TV 200 is described with reference to FIG. 10 and FIG. 11. The following discussion is based on the premise that two display devices to present the video content, namely, the TV 200 and the tablet terminal 300 are used.

FIG. 10 diagrammatically illustrates a specific example of such metadata. FIG. 10(a) diagrammatically illustrates csv data in a table format as an example of the metadata, and FIG. 10(b) illustrates XML data representing the same content as the csv data of FIG. 10(a). In FIG. 10, “listA” is the name of a group including components “compA-1” through “compA-4”, and “listB” is the name of a group including components “compB-1” through “compB-4”. FIG. 11 is a flowchart illustrating the operation of the modification 3 of the TV 200.

Referring to FIG. 11, first, the broadcasting reception unit 210 in the TV 200 receives the metadata of the video content while starting to receive the video content (S51).

The component separator 220 in the TV 200 determines whether the name of the i-th group from the front of the metadata is associated with “simul_on” or “simul_off” (S52). More specifically, if the metadata is data in the XML format, the component separator 220 determines whether the attribute value of attribute “device” of a first “group” tag from the front of the metadata is “simul_on” or “simul_off”.

Upon determining that the name of the i-th group is associated with “simul_on”” (“Yes” branch from S52), the TV 200 identifies each component belonging to the first group, starts transmitting each component to the tablet terminal 300 as a transmission destination (S53), and then proceeds to S54.

Upon determining the name of the i-th group is associated with “simul_off” (“No” branch from S52), the TV 200 proceeds to S54.

In S54, the component separator 220 in the TV 200 determines whether the operation in S52 has been performed on all the groups.

Upon determining that “there is still present a group that has not undergone the operation in S52” (“Yes” branch from S54), the TV 200 returns to S52 with an (i+1)-th group as a process target. On the other hand, upon determining that “the operation in S52 has been performed on all the groups” (“No” branch from S54), the TV 200 proceeds to S55.

In S55, the TV 200 starts presenting each component.

The operation in S55 completes the operation to start the presentation of the video content.

In a case that the TV 200 has received the metadata of FIG. 10 and the video content “cont2”, both the TV 200 and the tablet terminal 300 present each of the components “compA-1” through “compA-4”. Only the TV 200 presents the components “compB-1” through “compB-4”.

Appendix to Modification 3

The metadata transmitted from the transmitter apparatus 100 may include the presentation condition information on each multiplex component including a plurality of components. In such a case, the TV 200 may be configured to perform on each multiplex component a process of presenting each component forming the multiplex component in accordance with the presentation condition represented by the presentation condition information of the multiplex component.

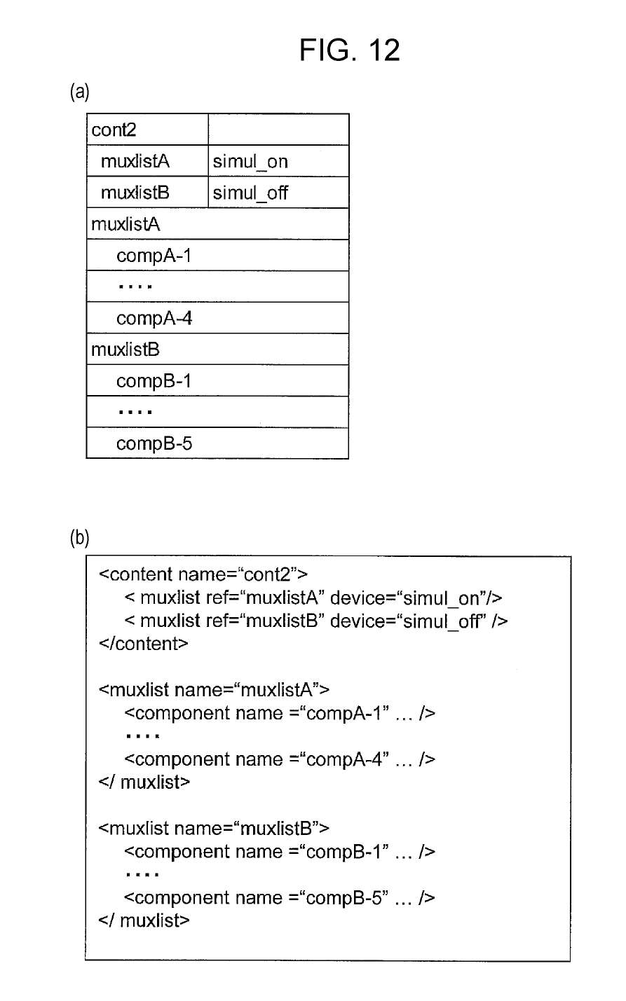

FIG. 12 diagrammatically illustrates a specific example of such metadata. FIG. 12(a) diagrammatically illustrates csv data in a table format as an example of the metadata, and FIG. 12(b) illustrates XML data representing the same content as the csv data of FIG. 12(a).

Referring to FIG. 12, a multiplex component “muxlistA” includes the components “compA-1” through “compA-4”, and a multiplex component “muxlistB” includes “compB-1” through “compB-4”.

In a case that the TV 200 constructed described above receives from the transmitter apparatus 100 the metadata of FIG. 12 and the video content “cont2” transmitted as two multiplex components, both the TV 200 and the tablet terminal 300 present each of the components “compA-1” through “compA-4”. Only the TV 200 presents each of the components “compB-1” through “compB-4”.

### Appendix to First Embodiment

The metadata may include specifications requirement information indicating a requirement in the specifications a device presenting the component is to meet. More specifically, the metadata may include the specifications requirement information of each component as part of the presentation condition information.

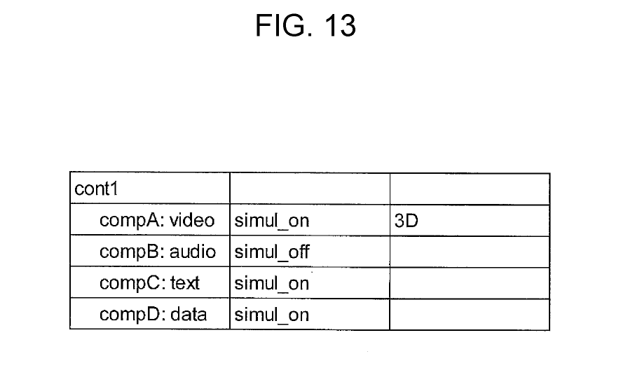

FIG. 13 diagrammatically illustrates a specific example of such metadata. The metadata of FIG. 13 includes, as the presentation condition information of the component “compA”, not only “simul_on” but also the specifications requirement information represented by a character string “3D”. The character string “3D” indicates that a device presenting the component “compA” needs to support a 3D display. The component “compA” is a video component produced in a 3D format.

In a case that the TV 200 receives the metadata of FIG. 13, the component separator 220 references the device management information on the device management information memory 230 to determine whether each of the TV 200, the tablet terminal 300-1, and the tablet terminal 300-2 supports the 3D display.

Upon determining that “the TV 200 supports the 3D display”, the component separator 220 supplies the component “compA” to the decoding unit 240. Upon determining that “any device other than the TV 200 (more specifically, the tablet terminal 300-1 or the tablet terminal 300-2) supports the 3D”, the component separator 220 transfers the component “compA” to the component transmission unit 280.

The component separator 220 notifies to the component transmission unit 280 the address of the device supporting the 3D display together with the component “compA”. The address is the address that the component separator 220 has read by referencing the device management information. The component transmission unit 280 transmits the component “compA” to the notified address.

In a case that the device management information memory 230 stores the device management information of FIG. 9, the component separator 220 determines that “the TV 200 and the tablet terminal 300-1 support the 3D display, and that the tablet terminal 300-2 does not support the 3D display”. The component separator 220 supplies the component “compA” to the decoding unit 240. The component separator 220 also supplies the component “compA” to the component transmission unit 280 while notifying the component transmission unit 280 of an address “YYY” of the tablet terminal 300-1. The component transmission unit 280 transmits the component “compA” to the tablet terminal 300-1 in response to the notified address “YYY” of the tablet terminal 300-1.

The TV 200 and the tablet terminal 300-1 present the component “compA” in a case that the device management information memory 230 stores the device management information of FIG. 9.

The tablet terminal 300-2 not supporting the 3D display does not receive the component “compA” from the TV 200. The TV 200 thus provides the benefit that “the operation thereof is free from an unnecessary process of transmitting the video content of 3D format to another device not supporting the 3D display”.

The remaining part of the specifications requirement information may include information 1) through 4) as described below.

1) Information of resolution that is to be supported by the device presenting the component. The information of resolution may be character strings such as “4K”, “HD”, “VGA”, or “QVGA” or vertical and horizontal pixel numbers, such as “3840×2160”, “1920×1080”, “640×480”, or “320×240”.

2) Information of frame frequency that is to be supported by the device presenting the component (for example, 120 Hz, 60 Hz, 30 Hz, and 15 Hz).

3) Types of device to present the component (for example, “TV”, “tablet terminal”, and “digital book reader”)

4) Elements to be built in the device presenting the component (for example, “display panel”, “speaker”, “vibrator”, and “illumination”)

In such a case, an audio component having the specifications requirement information specifying “speaker” is presented only on a device having a built-in speaker (the TV 200 and the tablet terminal 300-1 in the example of FIG. 9). A video component having the specifications requirement information specifying a “display panel” is presented on a device having a built-in display panel (the TV 200 and the tablet terminals 300-1 and 300-2 in the example of FIG. 9).

An audio component having the specifications requirement information specifying a “vibrator” is presented only on a device having a built-in vibrator (the TV 200 and the tablet terminal 300-2 in the example of FIG. 9).

If the specifications requirement information of a target component specifies information of resolution, the target component may be presented only on a device supporting the specified resolution. The devices presenting the target component may include a device supporting a resolution equal to or higher than the specified resolution.

Advantages of the TV 200

As described above, the TV 200 causes two devices (the TV 200 itself and the tablet terminal 300) to display the video content based on the metadata of the video content including the video component.

The component separator 220 in the TV 200 decides from the two devices a device that presents the video component, and thus causes one or more devices (the TV 200 alone, the tablet terminal 300 alone, or both the TV 200 and the tablet terminal 300) to present the video component in accordance with the decision.

The metadata includes the presentation condition information (display condition information) that specifies whether to grant the permission for the video content to be presented simultaneously on two or more devices. If the reference to the presentation condition information indicates that the permission is not granted, the component separator 220 decides one device that presents the video content in accordance with a predetermined criteria.

If the metadata is produced reflecting the intention of the content provider, the TV 200 in the above-described configuration presents the video content on one or more devices in a presentation form reflecting the intention of the content provider.

For example, if the content provider “does grant the permission for the video to be presented simultaneously on two or more devices”, and the metadata including the presentation condition information reflecting the provider's intention (for example, the metadata including the name “compA” of the video content and the character string “simul_off” associated with each other) may be produced. The TV 200 then permits a single device to present the video content.

The TV 200 controls the presentation form of the video content on the TV 200 and the tablet terminal 300 such that the video content is presented in a manner reflecting the intention of the content provider.

### Second Embodiment

A delivery system of another embodiment of the present invention is described below.

The delivery system of the present embodiment includes a transmitter apparatus configured to deliver the video content through broadcasting, a transmitter apparatus configured to deliver the video content through communications, and two display devices configured to present the video content (TV and tablet terminals). The video content includes a plurality of components.

The TV references meta information that is delivered together with the video content from the transmitter apparatus, and then decide whether to present the component the TV itself or to cause the tablet terminal to present the video content.

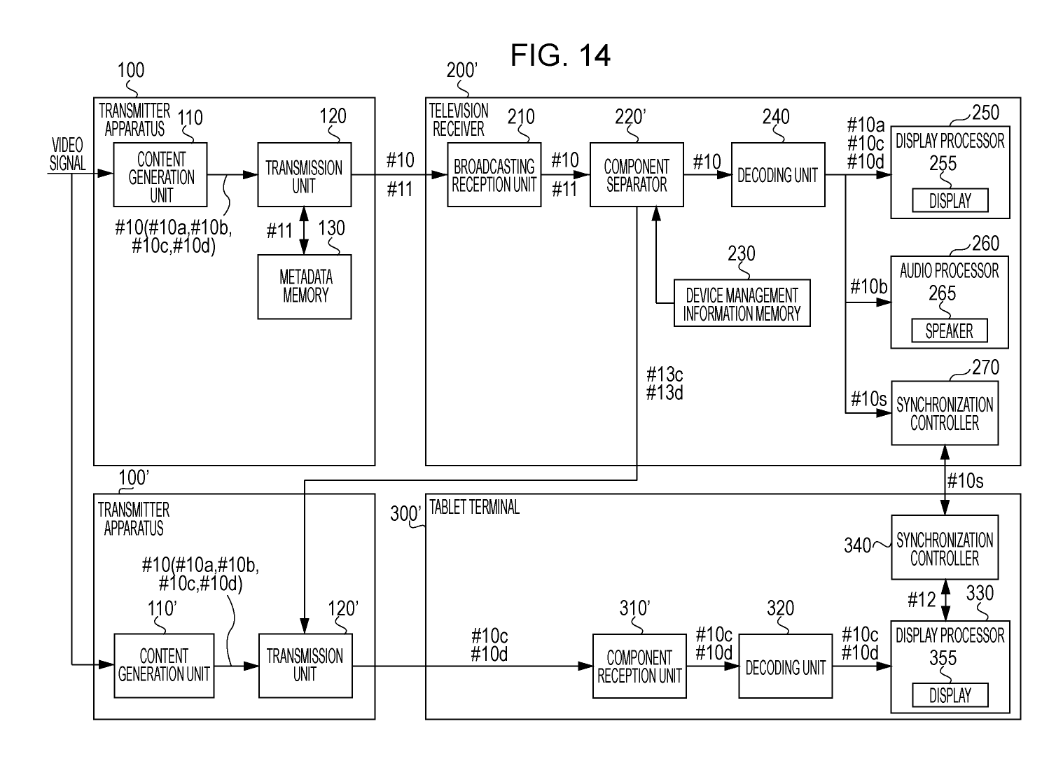

The main portion of the two transmitter apparatuses forming the delivery system of the present embodiment and each of the TV and the tablet terminal is described below with reference to FIG. 14.

FIG. 14 is a block diagram illustrating the main portion of each device.

As illustrated in FIG. 14, the delivery system 1 includes the transmitter apparatuses 100 and 100′, the TV 200′, and the tablet terminal 300′.

The transmitter apparatus 100 delivers the video content through broadcasting, and has been discussed with reference to the first embodiment and the detailed discussion thereof is omitted herein.

### TV 200′

The TV 200′ includes the broadcasting reception unit 210, a component separator 220′, the device management information memory 230, the decoding unit 240, the display processor 250, the audio processor 260, and the synchronization controller 270. The broadcasting reception unit 210, the device management information memory 230, the decoding unit 240, the display processor 250, the audio processor 260, and the synchronization controller 270 have been described with reference to the first embodiment, and the discussion thereof is omitted herein.

The component separator 220′ separates, from the video content obtained through the reception of the broadcasting wave, a video component, an audio component, a data component, and a subtitle component.

The component separator 220′ references the metadata of the video content and then decides whether to present each component on the television receiver 200′ or on the tablet terminal 300′. The component separator 220′ supplies to the decoding unit 240 the component that is decided to be presented on the TV 200.

Upon deciding to cause the tablet terminal 300′ to present the component, the component separator 220′ transmits to the transmitter apparatus 100′ the component that is to be presented on the tablet terminal 300′. More specifically, the component separator 220′ transmits to the transmitter apparatus 100′ a request including an address as a transmission destination of the component from the transmitter apparatus 100′ (in other words, an address of the tablet terminal 300′) and the name of the component to be transmitted to the address. For example, if the metadata of FIG. 3 is referenced, the component separator 220′ transmits to the transmitter apparatus 100′ request data #13c including the name “compC” of a component, and request data #13d including the name “compD” of a component. The component separator 220′ references the device management information while identifying the address of the tablet terminal 300′ to be included in the request data.

### Transmitter Apparatus 100′

The transmitter apparatus 100′ transmits the video content through communications. The transmitter apparatus 100′ includes a content generation unit 110′ and a transmission unit 120′.

The content generation unit 110′ generates data of the video content by performing a coding operation on a video signal input from outside the transmitter apparatus 100′.

Upon receiving the request of a component, the transmission unit 120′ transmits the component to a device having an address specified in the request via a communication network. In response to the reception of the address of the tablet terminal 300′ and the request data #13c including the name “compC” of the component, the transmission unit 120′ transmits a text component #10c to the tablet terminal 300′. Similarly, in response to the reception of the address of the tablet terminal 300′ and the request data #13d including the name “compD” of the component, the transmission unit 120′ transmits a data component #10d to the tablet terminal 300′.

Tablet Terminal 300′

The tablet terminal 300′ includes a component reception unit 310′, the decoding unit 320, the display processor 330, and the synchronization controller 340. The decoding unit 320, the display processor 330, and the synchronization controller 340 have been discussed with reference to the first embodiment, and the component reception unit 310′ is described below.

The component reception unit 310′ is on standby waiting for the reception of a component from the transmitter apparatus 100′. Upon receiving the component, the component reception unit 310′ supplies the received component to the decoding unit 320.

Communications between the component reception unit 310′ and the transmission unit 120′ may be performed through FTP protocol, for example.

More specifically, an FTP client application may be installed on the transmitter apparatus 100′, and an FTP server application may be installed on the tablet terminal 300′. In this case, the component reception unit 310′ is on standby waiting for a component by enabling an FTP service. The transmission unit 120′ transmits a component to the tablet terminal 300′, by logging in on an FTP server, and uploading a component using a PUT command.

In the delivery system thus constructed, the television receiver 200′ controls the presentation form of the video content on the television receiver 200′ and the tablet terminal 300′ so that the video content is presented in a manner reflecting the intention of the content provider.

### Appendix 1

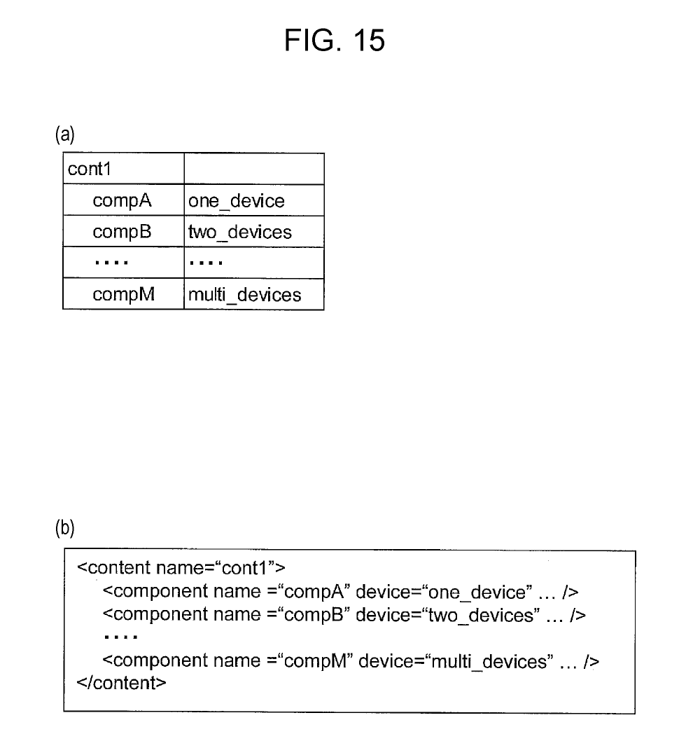

In a case that the display system includes N devices (N≧3) including the TV 200, the TV 200 may select one or more devices to present the component from among the N devices in accordance with metadata illustrated in FIG. 15. FIG. 15 specifically illustrates the metadata.

As illustrated in FIG. 15, the metadata includes three types of presentation condition information “one_device”, “two_devices”, and “multi_devices” on each component of the video content. Here, “one_device” indicates that the number of devices enabled to present the component is one. Similarly, “two_devices” indicate that the number of devices enabled to present the component is two. On the other hand, “multi_devices” indicate that there is no limit to the number of devices enabled to present the component.

If the metadata is received by the TV 200, the component separator 220 in the TV 200 may select a device to present the component from the N devices according to a predetermined criteria. For example, if the metadata of FIG. 15 is received by the TV 200, the component separator 220 may select a device to present the component “compA”, may select two devices to present the component “compB”, and may present the component “compM” on the N devices. In order to select one device to present the component, the component separator 220 may select the device having the attribute information “first device” assigned thereto. In order to selects two devices to present the component, the component separator 220 may select the device with the attribute information “first device” assigned thereto and the device with the attribute information “second device” assigned thereto.

### Appendix 2

The tablet terminal 300 may include the broadcasting reception unit 210, and the broadcasting reception unit 210 in the tablet terminal 300 may receive the video content and the metadata of the video content from the transmitter apparatus 100. The tablet terminal 300 may include the component separator 220, and the component separator 220 in the tablet terminal 300 may decide, based on the received metadata, whether to present the component on the TV 200 or on the tablet terminal 300.

The tablet terminal 300 and the TV 200 may respectively include the component reception unit 310 and the component transmission unit 280, and the component transmission unit 280 in the tablet terminal 300 may transmit to the TV 200 the component to be presented to the TV 200. The component reception unit 310 in the TV 200 may supply to the decoding unit 240 the component received from the tablet terminal 300.

In this way, the tablet terminal 300 is configured to control the presentation form on the TV 200 and the tablet terminal 300 so that the video content is presented in a way reflecting the intention of the content provider.

### Appendix 3

The TV 200 may be configured so that the component separator 220 analyzes not only the XML data and the csv data of FIG. 3 but also metadata in another format. More specifically, the TV 200 may be configured to analyze other table format data (such as xls data) having the same contents as the csv data of FIG. 3, or other tree format data having the same contents as the XML data of FIG. 3.

### Appendix 4

The video content and the metadata of the video content may not necessarily be delivered from the transmitter apparatus 100. More specifically, the video content and the metadata of the video content may be stored on a recording medium. In a case that the TV 200 reads from the recording medium the video content and the metadata of the video content to reproduce the video content, the component separator 220, and the decoding unit 240 through the component transmission unit 280 may perform the same operations described with reference to the first embodiment.

The metadata of the video content may not necessarily include the presentation condition information of some components included in the video content. For example, the presentation condition information included in the metadata of the video content may be only the presentation condition information of the video content. In other words, the metadata of the video content may not necessarily include the presentation condition information of the audio component.

### Appendix 5

MMT (MPEG media transport) may be used as a transmission method of the video content. In this case, a package in MMT corresponds to the video content and an asset in MMT corresponds to a component.

### Appendix 6

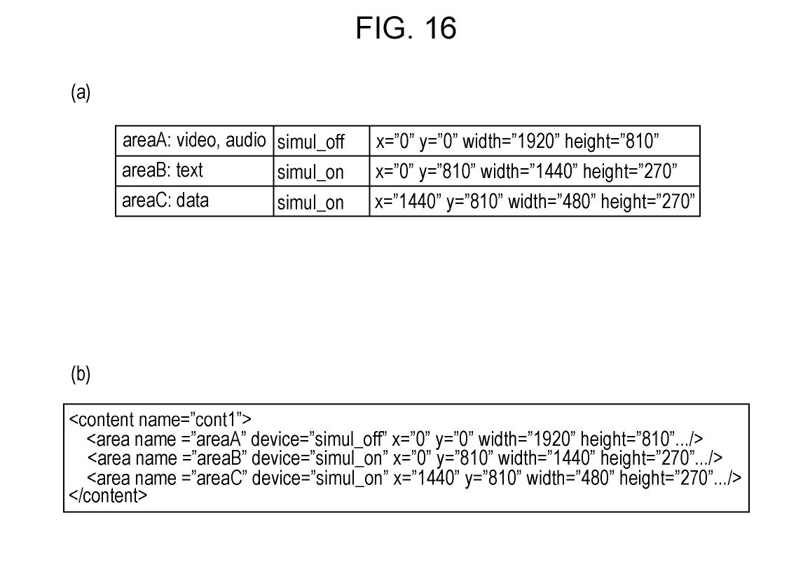

The metadata of the video content may not necessarily include the presentation condition information such as “simul_on” and “simul_off” on each component of the video content. More specifically, as illustrated in FIG. 16, the metadata may include information of a region of a display where each component is displayed, and the presentation condition information, such as “simul_on” and “simul_off”, on each region.

The metadata of the video content includes information representing a display location of the region of the display where each component is displayed, and a display size and a display range on each region. For example, as illustrated in FIG. 16, the display range is represented using reference coordinates (for example, coordinates of the top left corner (“x”, “y”)), a width (“width”), and a height (“height”). The metadata may include the display size of the component and the shape of the display range (rectangular, or circular). In a case that the display location and the display size of the region are different from a display enabled region, the device may modify the display location and the display size of the region.

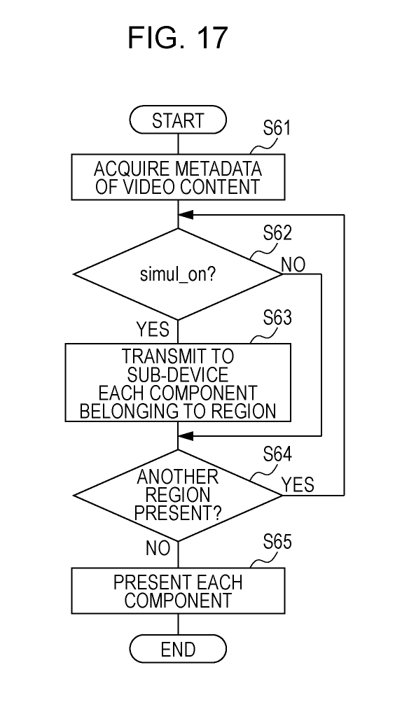

In response to the reception of the metadata, the TV 200 may be configured to perform the operation related to Appendix 6. The operation related to the TV 200 of Appendix 6 is described with reference to FIG. 16 and FIG. 17. The following discussion is based on the premise that the two display apparatuses to present the video content, namely, the TV 200 and the tablet terminal 300 are used.

FIG. 16 diagrammatically illustrates a specific example of such metadata. FIG. 16(a) diagrammatically illustrates csv data in a table format as an example of the metadata, and FIG. 16(b) illustrates XML data representing the same content as the csv data of FIG. 16(a). In FIG. 16, “areaA” through “areaC” respectively represent the name of regions where component names of video, audio, text, and data are presented. FIG. 17 is a flowchart illustrating the operation related to Appendix 2 of the first embodiment of the TV 200.

As illustrated in FIG. 17, first, the broadcasting reception unit 210 in the TV 200 receives the metadata of the video content while starting to receive the video content (S61).

The component separator 220 in the TV 200 determines whether the name of an i-th region from the front of the metadata is associated with “simul_on” or “simul_off” (S62). More specifically, if the metadata is in the XML format, the component separator 220 determines whether the attribute value of attribute “device” of a first “area” tag from the front of the metadata is “simul_on” or “simul_off”.

Upon determining that “the name of the i-th region is associated with ‘simul_on’” (“Yes” branch from S62), the TV 200 identifies each component belonging to the first region, starts transmitting each component to the tablet terminal 300 as a transmission destination (S63), and then proceeds to S64.

Upon determining that “the name of the i-th region is associated with ‘simul_off’” (“No” branch from S62), the TV 200 proceeds to S64.

In S64, the component separator 220 in the TV 200 determines whether the operation in S62 has been performed on all the regions.

Upon determining that “there is still present a region that has not undergone the operation in S62” (“Yes” branch from S64), the TV 200 returns to S62 with an (i+1)-th region as a process target. On the other hand, upon determining that “the operation in S62 has been performed on all the regions” (“No” branch from S64), the TV 200 proceeds to S65.

In S65, the TV 200 starts presenting each component.

The operation in S65 completes the operation to start presenting the video content.

In a case that the TV 200 has received the metadata of FIG. 16 and video content “cont1”, only the TV 200 presents each component of “areaA”. Both the TV 200 and the tablet terminal 300 present each component of “areaB” and “areaC”.

The presentation condition information on each region different from those above may include information indicating region presentation permission on a per display basis. In such a case, three or more display devices to present the video content may be used. For example, the main device presents the component of the region (such as “main_device), the second device may present the component of the region (such as “second_device”), or the third_device may present component of the region (such as “third_device”).

In the video content or the like, a screen is typically partitioned into a plurality of regions in order to present a plurality of components over the regions. As described above, the attribute information as to whether to permit the content to be simultaneously presented on multi devices is added to each presentation region of content. This arrangement permits the device to be specified using a smaller amount of data than specifying the presentation to the multi devices on a per component basis.

### Appendix 7

Presentation condition information different from the above presentation condition information may include a combination of a plurality of pieces of presentation condition information. For example, the use of logical product (AND) of “simul_on” and “second_device” does not cause the main device to present the content but indicates presentation grant to only the sub device. This may be defined as one attribute (such as “sub_only_on”). Further information a) through c) may be defined as below.

a) Information indicating presentation permission of the content presented on the sub device to the main device (for example, defined by “insert_on”)

b) Information indicating presentation permission of the content to the main device or the content to the sub device (such as “alt_on”)

c) Information configured to enable the user to select between presenting the content on the main device and presenting the content on the sub device (such as “user_on”). For example, the information is configured to allow the user to have one of three choices, namely, in a first choice, the user may select simultaneous presentation on the main device and the sub device, in a second choice the content is presented only on the sub device but not on the main device, or in a third choice, the content is presented only on the main device but not on the sub device.

Program and Storage Medium

Each element of the TV 200 may be implemented using a logical circuit formed on an integrated circuit (IC chip) in a hardware fashion, or using a CPU (Central Processing Unit) in a software fashion.

If each element is implemented in a software fashion, the TV 200 includes a CPU that executes an instruction of a program that performs each function, a ROM (Read Only Memory) that stores the program, a RAM (Random Access Memory) that expands the program, and a storage device (recording medium), such as a memory, that stores the program and a variety of data. A recording medium that stores in a computer readable fashion a program code (an executable program, an intermediate code program, or a source program) of a control program of the TV 200 as software that implements the functions is supplied to the TV 200. The computer (or a CPU or an MPU) reads the program recorded on the recording medium and executes the program. The object of the present invention is thus achieved.

The recording media include a tape type of media, such as a magnetic tape or a cassette tape, a disk type of media including a magnetic disk, such as a Floppy (Registered Trademark) disk/hard disk, and an optical disk, such as a CD-ROM/MO/MD/DVD/CD-R/Blue-Ray Disc (Registered Trademark), a card type of medium, such as IC card (including a memory card)/optical card, a semiconductor memory type of medium, such as a mask ROM/EPROM/EEPROM (Registered Trademark)/flash ROM, or a logical circuit type medium, such as PLD (Programmable logic device) or FPGA (Field Programmable Gate Array).

The TV 200 may be supplied with the program code via the communication network. The communication network may simply transmit the program code and is not limited to any particular one. For example, usable as the communication network may be any of the Internet, intranet, extranet, LAN, ISDN, VAN, CATV communication network, Virtual Private Network, telephone network, mobile communication network, and satellite communication network. A transmission medium forming the communication network may be any medium as long as the medium transmits the program code, and is not limited to any particular configuration or any particular type. For example, usable as the transmission medium may be any of wired networks including IEEE (Institute of Electrical and Electronic Engineers) 1394, USB, power-line carrier, cable TV network, telephone line, ADSL (Asymmetrical Digital Subscriber Line) network, and may be any of wireless networks including infrared of IrDA or a remote control, Bluetooth (Registered Trademark), IEEE802.11 radio, HDR (High Data Rate), NFC (Near Field Communication), DLNA (Digital Living Network Alliance), cellular phone network, satellite communication network, and terrestrial digital network.

The embodiments disclosed herein have been discussed for exemplary purposes only, and should not be construed as limiting the present invention. The scope of the present invention is not limited to the embodiments described above. The present invention is intended to cover all modifications and equivalents as may be included within the scope of the invention as defined by the appended claims.

The presentation control apparatus is enabled to present the video content on the N devices (N≧2) based on the metadata of the video content. The presentation control apparatus includes a decision unit configured to decide from among the N devices a device that is to present a video component included in the video content, and a presentation control unit configured to cause one or more devices to present the video component in accordance with a decision of the decision unit. The metadata includes presentation condition information as to whether to permit the video component to be simultaneously presented on two or more devices. The decision unit is configured to decide from among the N devices a device that is to present the video component in a case that a reference to the presentation condition information determines the simultaneous presentation of the component to be not permissible.

The presentation control apparatus may be one of the N devices or may be a device different from the N devices. In the former case, a device to be decided as the one device may be the presentation control apparatus itself of the present embodiment. The metadata may be data different from the video content, or may be data included in the video content. The presentation condition information may explicitly or implicitly indicate the grant to permit the video content to be simultaneously presented on the two or more devices.

As long as the metadata of the video content is produced reflecting the intention of the content provider, the presentation control apparatus of the present invention configured described above presents the video content on one or more devices in a presentation form reflecting the intention of the content provider.

For example, the content provider may intend “not to grant the permission to simultaneously display a video on two or more devices”, and the metadata including the presentation condition information reflecting that intention may be produced. The presentation control apparatus of the invention causes only one device to present the video content.

The presentation control apparatus of the present invention thus controls the presentation form of the video content so that the video component is presented on each device in a manner reflecting the intention of the content provider.

The presentation control method of a presentation control apparatus of the present invention is enabled to present video content on N devices (N≧2) based on metadata of the video content. The present control method includes a decision step of deciding from among the N devices a device that is to present a video component included in the video content, and a presentation control step of causing one or more devices to present the video component in accordance with a decision of the decision step. The metadata includes presentation condition information as to whether to permit the video component to be simultaneously presented on two or more devices. The decision step includes deciding from among the N devices a device to present the video component in a case that a reference to the presentation condition information determines the simultaneous presentation of the component to be not permissible.

In the above-described configuration, the presentation control method of the present invention has the same advantageous effects as those of the presentation control apparatus of the present invention.

In the presentation control apparatus of the present invention, the video content preferably includes a plurality of components. The decision unit is configured to decide from among the N devices a device that is to present each component included in the video content. The presentation condition information is information on each component indicating whether or not the component is permitted to be simultaneously presented on the two or more devices. The decision unit is configured to decide from among the N devices a device to present the component in a case that the reference to the presentation condition information determines the simultaneous presentation of the content to be not permissible.

In the above-described configuration, the presentation control apparatus of the present invention provides the advantage that the presentation control apparatus controls the presentation form of each component on each device such that the component of the video content is presented in a manner that reflects the intention of the content provider.

The metadata preferably includes information indicating a plurality of groups with each component belonging to one of the groups. The presentation condition information is preferably information on each of the groups as to whether or not each component belonging to one of the groups is permitted to be simultaneously presented on two or more devices.

The presentation condition information is preferably information on each component as to whether the component is permitted to be simultaneously presented on the N devices or only on a single device. The decision unit is preferably configured to decide the simultaneous presentation of the component on the N devices on the component in a case that the component is permitted to be simultaneously presented on the N devices.

The presentation control apparatus preferably includes a memory. The memory stores specifications information indicating specifications of each of the N devices. The metadata includes on each component specifications requirement information indicating a requirement in the specifications a device presenting the component is to satisfy. The decision unit is configured to decide on each component as a device presenting the component a device having the specifications, indicated by the specifications information, and satisfying the requirement indicated by the specifications requirement information of the component.

As long as the metadata of the video content is produced reflecting the intention of the content provider, the presentation control apparatus of the present invention thus configured allows to present the component only a device that satisfies a requirement in the specifications the content provider considers necessary to present the component. The presentation control apparatus of the present invention thus controls the presentation form of the video content on each device so that the component is presented reflecting the intention of the content provider.

In the presentation control apparatus of the present invention, the metadata is preferably data different from the video content.

In the above-described configuration, the presentation control apparatus of the present invention further provides the advantage that the presentation control apparatus controls the presentation form of the video content on each device such that the video content is presented in a manner reflecting the intention of the content provider without the need to analyze the video content itself.

The presentation control apparatus of the present invention further includes a receiver configured to receive the video content and the metadata from a delivery server.

In the above-described configuration, the presentation control apparatus of the present invention further provides the advantage that the presentation control apparatus controls the presentation form of the video content on each device such that the video content delivered by the delivery server is presented in a manner reflecting the intention of the content provider.

In the presentation control apparatus of the present invention, the video content preferably includes a plurality of components. The receiver includes a first reception unit configured to receive some components included in the video content by receiving a broadcasting wave, and a second reception unit configured to receive through a communication network from the delivery server the remaining components included in the video content. The first reception unit or the second reception unit is configured to receive the metadata.

In the above-described configuration, the presentation control apparatus of the present invention further provides the advantage that the presentation control apparatus controls the presentation form of the video content on each device such that the video content delivered through hybrid transmission is presented in a manner reflecting the intention of the content provider.

A presentation system may include the presentation control apparatus of the present invention. The presentation system further including the N devices falls within the scope of the present invention. As described above, the presentation control apparatus may be one of the N devices, or a device different from the N devices.

A presentation control program causing a computer as the presentation control apparatus of the present invention, and causing the computer to function as each of the elements of the presentation control apparatus falls within the scope of the present invention. A computer readable recording medium having stored such a presentation control program also falls within the scope of the present invention.

The metadata of the video content also falls within the scope of the present invention. More specifically, the metadata is configured to be referenced by the presentation control apparatus of the present invention enabled to present video content including a video component on N devices (N2). The metadata includes presentation condition information indicating whether to permit the video component to be presented simultaneously on two or more devices. Such metadata falls within the scope of the present invention.

### INDUSTRIAL APPLICABILITY

The present invention is applicable to a TV, a tablet terminal, a smartphone, and the like.

### REFERENCE SIGNS LIST

100 Transmitter apparatus
100′ Transmitter apparatus (delivery server)
110 and 110′ Content generation unit
120 and 120′ Transmission unit
130 Metadata memory
200 TV (presentation control apparatus, device)
210 Broadcasting reception unit (receiver, first receiver unit)
220 Component separator (decision unit, presentation control unit)
230 Device management information memory (memory)
240 Decoding unit
250 Display processor
255 Display
260 Audio output unit
265 Speaker
270 Synchronization controller
280 Component transmission unit
300 Tablet terminal (device)
310 Component reception unit
310′ Component reception unit (receiver, second reception unit)
320 Decoding unit
330 Display processor
335 Display
340 Synchronization controller

1.-13. (canceled)

14. A presentation control apparatus enabled to present video content based on metadata of the video content, comprising:
a decision unit configured to decide a presentation device or a presentation region that is to present a video component included in the video content; and
a presentation control unit configured to cause the presentation device or the presentation region decided by the decision unit to present the video component,
wherein the metadata includes presentation condition information as to whether to permit the video component to be simultaneously presented on a plurality of presentation devices or a plurality of presentation regions, and
wherein the decision unit is configured to decide the presentation device or the presentation region to present the video component in accordance with the presentation condition information.

15. The presentation control apparatus according to claim 14, wherein the decision unit decides only a presentation device or only a presentation region to present the video component in a case that the presentation condition information indicates that the video component can't be simultaneously presented among two or more presentation devices or two or more presentation regions.

16. The presentation control apparatus according to claim 14, wherein the decision unit decides two or more presentation devices or two or more presentation regions to present the video component in a case that the presentation condition information indicates that the video component can be simultaneously presented among two or more presentation devices or two or more presentation regions.

17. The presentation control apparatus according to claim 14, wherein the metadata is data different from the video content.

18. The presentation control apparatus according to claim 17, further comprising a receiver configured to receive the video content and the metadata from a delivery server.

19. A presentation control method enabled to present video content based on metadata of the video content, comprising:
a decision step of deciding a presentation device or a presentation region that is to present a video component included in the video content; and
a presentation control step of causing the presentation device or the presentation region decided by the decision unit to present the video component,
wherein the metadata includes presentation condition information as to whether to permit the video component to be simultaneously presented on a plurality of presentation devices or a plurality of presentation regions, and
wherein the decision step includes deciding the presentation device or the presentation region to present the video component in accordance with the presentation condition information.

20. The presentation control method according to claim 19, wherein the decision step comprises deciding only a presentation device or only a presentation region to present the video component in a case that the presentation condition information indicates that the video component can't be simultaneously presented among two or more presentation devices or two or more presentation regions.

21. The presentation control method according to claim 19, wherein the decision step comprises deciding two or more presentation devices or two or more presentation regions to present the video component in a case that the presentation condition information indicates that the video component can be simultaneously presented among two or more presentation devices or two or more presentation regions.
